(19) United States
(12) Patent Application Publication
(10) Pub. No.: US 2007/0052473 A1
(43) Pub. Date: Mar. 8, 2007

(54) Perfectly curvature corrected bandgap reference

(75) Inventor: Scott C. McLeod, Oro Valley, AZ (US)

Correspondence Address: MEYERTONS, HOOD, KIVLIN, KOWERT & GOETZEL, P.C., 700 LAVACA, SUITE 800, AUSTIN, TX, 78701, US

(73) Assignee: Standard Microsystems Corporation

(21) Appl. No.: 11/219,071

(22) Filed: Sep. 2, 2005

(51) Int. Cl. G05F 1/10

(52) U.S. Cl. 327/539

(57) ABSTRACT

In one embodiment, a bandgap voltage reference generating circuit is configured to generate a reference voltage, and may comprise a first PN-junction whose base-emitter voltage (V_{BE}) exhibits a curvature with respect to temperature, where a current conducted by the first PN-junction is proportional to absolute temperature (PTAT). The voltage reference generating circuit may also include a second PN-junction coupled to the first PN-junction. A control circuit coupled to the second PN-junction may be configured to inject a control current into the second PN-junction, where the control current has a negative to absolute temperature (NTAT) characteristic, the control circuit thereby operating to effectively eliminate a curvature with respect to temperature exhibited by the bandgap voltage.

### BACKGROUND OF THE INVENTION

1. Field of the Invention

This invention relates generally to the field of integrated circuit design and, more particularly, to the design of bandgap references.

2. Description of the Related Art

Many digital systems, especially those that include high-performance, high-speed circuits, are prone to operational variances due to temperature effects. Devices that monitor temperature and voltage are often included as part of such systems in order to maintain the integrity of the system components. Personal computers (PC), signal processors and high-speed graphics adapters, among others, typically benefit from such temperature monitoring circuits. For example, a central processor unit (CPU) that typically “runs hot” as its operating temperature reaches high levels may require a temperature sensor in the PC to insure that it doesn't malfunction or break due to thermal problems.

Often, integrated circuit (IC) solutions designed to measure temperature in a system will monitor the voltage across one or more PN-junctions, for example one or more diodes, at different current densities, to extract a temperature value. This is often accomplished by measuring a difference in voltage across the terminals of typically identical diodes, when different current densities are forced through the PN junctions of the diodes. The resulting change (ΔV_{BE}) in the base-emitter voltage (V_{BE}) between the diodes is generally proportional to temperature. (It should be noted that while V_{BE} generally refers to a voltage across the base-emitter junction of a diode-connected transistor and not a voltage across a simple PN-junction diode, for the sake of simplicity, V_{BE} is used herein to refer to the voltage developed across a PN-junction in general.) In general, V_{BE} may be defined as a function of absolute temperature by the equation

$${V}_{BE} = η \frac{kT}{q} ln \frac{{I}_{C}}{{I}_{S}} \qquad ( 1 )$$

where η is the ideality factor of the PN junction, k is Boltzman's constant, q is the charge of a single electron, T represents absolute temperature, Iₛ represents saturation current and I_{c} represents the collector current. A more efficient and precise method of obtaining ΔV_{BE} is to supply the PN junction of a single diode with two separate and different currents in a predetermined ratio

ADCs, such as the ones used in temperature measurement systems, require a precise reference voltage to function accurately and reliably. In general, many different devices and technologies may require temperature-stable reference voltages. A common circuit used to provide such a reference voltage is a bandgap voltage reference circuit. Bandgap voltage reference circuits typically operate by summing a base-emitter voltage (V_{BE}) of a bipolar junction transistor (BJT), which has a negative temperature drift, with a thermal voltage Vₜ that has a positive temperature drift. The thermal voltage Vₜ is typically dependent on the difference between V_{BE} of two BJTs operating at different emitter current densities. The value of the resulting bandgap voltage V_{BG} (V_{ref}) is the sum of V_{BE} of one BJT and a quantity proportional to the difference in V_{BE} between two BJTs.

Typically, the output of a bandgap voltage reference circuit has a residual curvature that has a non-zero temperature coefficient (TC) for values of temperature other than a nominal operating temperature. In some applications, errors in the output voltage that arise due to this non-zero temperature coefficient may be unacceptable. It is therefore desirable to design a zero TC bandgap reference for generating the reference voltage used by a given ADC that is part of a temperature measurement system.

The need for curvature correction may arise for a wide operating temperature range, such as −40° C. to +125° C., for example. A typical bandgap reference may exhibit a certain degree of curvature over such a wide temperature range (for example, 4.5 mV for a range of −40° C. to +125° C.), which generally results in a variation in the temperature sensor output (for example, an 0.8° C. of variation for a 4.5 mV curvature). In other words, at the endpoint temperatures the temperature measurements may rise in accordance with the exhibited curvature of the bandgap reference. Therefore, reduction of this curvature may lead to increased accuracy in the temperature measurements. However, correction circuitry to perform the curvature correction may be complicated. The performance of the correction circuitry itself may also be subject to errors that arise due to process variations.

Other corresponding issues related to the prior art will become apparent to one skilled in the art after comparing such prior art with the present invention as described herein.

### SUMMARY OF THE INVENTION

In one set of embodiments, a bandgap reference voltage generating circuit may generate a reference voltage that is perfect and/or completely curvature corrected. In one embodiment, a negative to absolute temperature (NTAT) current is injected into the emitter of a low emitter current density transistor in a positive to absolute temperature (PTAT) current circuit, thereby generating a T ln(T) current component, which perfectly cancels the curvature term in a diode used in generating the reference voltage, leaving only the bandgap voltage as the reference voltage.

In one embodiment, a bandgap voltage reference generating circuit may comprise a first PN-junction whose base-emitter voltage (V_{BE}) exhibits a curvature with respect to temperature, where a current conducted by the first PN-junction may be proportional to absolute temperature (PTAT). The voltage reference generating circuit may also include a second PN-junction coupled to the first PN-junction. A control circuit coupled to the second PN-junction may be configured to inject a control current into the second PN-junction, where the control current has a negative to absolute temperature (NTAT) characteristic. The control current may operate to effectively eliminate a curvature with respect to temperature exhibited by a reference voltage generated by the bandgap voltage reference generating circuit.

In one embodiment, a bandgap voltage reference generating circuit includes a first operational amplifier (op-amp) whose output is configured as the reference voltage output, with the PN junctions comprised in respective bipolar junction transistors. The BJT corresponding to the first PN-junction may be coupled to the non-inverting input of the first op-amp, while the BJT corresponding to the second PN-junction may be coupled to the inverting input of the first op-amp. Each BJT may be a PNP transistor with its emitter coupling to the corresponding op-amp input terminal. The control circuit may comprise two PMOS devices and a second op-amp. The gate of each PMOS device may be coupled to the output of the second op-amp, with the drain of one of the PMOS devices coupling to the non-inverting terminal of the second op-amp, and the drain of the other PMOS device coupling to the emitter of the BJT corresponding to the second PN-junction. Additionally, the inverting input of the second op-amp may be coupled to the emitter of the BJT corresponding to the first PN-junction.

In one embodiment, operating a bandgap voltage reference generating circuit may include: powering the bandgap reference circuit, where the bandgap reference circuit comprises a first PN-junction coupled to a second PN-junction, and in response to powering the circuit, a V_{BE} of the first PN-junction exhibits a non-linearity (curvature) with respect to temperature. Also in response to powering the bandgap voltage reference generating circuit, the first PN-junction may conduct a current that is proportional with respect to absolute temperature. In one set of embodiments, by injecting a control current into the second PN-junction, with the control current having a negative to absolute temperature characteristic, a curvature (resulting from the V_{BE} of the first PN junction exhibiting a curvature with respect to temperature) exhibited by the reference voltage generated by the bandgap voltage reference generating circuit may effectively be corrected and/or eliminated.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates a common bandgap reference circuit; and

FIG. 2 illustrates one embodiment of a bandgap reference circuit according to the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “coupled” means “directly or indirectly connected”.

### DETAILED DESCRIPTION OF THE PREFERRED EMBODIMENTS

As used herein, the word “alternately” is meant to imply passing back and forth from one state, action, or place to another state, action, or place, respectively. For example, “alternately applying a first current source and a second current source” would mean applying the first current source, then applying the second current source, then applying the first current source, then applying the second current source, and so on.

A “diode-junction-voltage” (V_{BE}) refers to a voltage measured across the junction of a diode, or a difference in voltage between a voltage measured at the anode of the diode junction with respect to a common ground and a voltage measured at the cathode of the diode junction with respect to the common ground. A diode is one device comprising a PN-junction across which voltage V_{BE} may be developed. More generally, diode-junction may also mean PN-junction or NP-junction, which defines the physical attributes of the junction across which V_{BE} may be developed. In certain embodiments, the operation performed by a diode may be achieved using other circuitry, such as a PN-junction (or NP-junction) present in devices other than a diode, for example in bipolar junction transistors (BJTs). Therefore, the terms PN-junction, NP-junction, diode, diode-junction, and V_{BE} junction are used interchangeably, and all respective terms associated therewith may be interpreted accordingly.

In one set of embodiments, a bandgap reference may be configured to form a reference voltage through a V_{BE} junction. In such bandgap references, a curvature may be observed due to the non-linearity of the V_{BE} junction used by the bandgap reference to provide the reference voltage to various designated data conversion circuits. The relationship between V_{BE} and absolute temperature T shown in equation (1) may be re-written in equation (2), showing the non-linear curvature produced by the temperature dependent nature of I_{S}. V_{BE} in equation (2) may represent the voltage across the V_{BE} junction used by a bandgap reference to form a reference voltage. Thus,

$${V}_{BE} ( T ) = {V}_{go} - \frac{T}{{T}_{r}} [ {V}_{go} - {V}_{BE} ( {T}_{r} ) ] - [ ( 4 - n ) - x ] \frac{η kT}{q} ln ( \frac{T}{{T}_{r}} ) \qquad ( 2 )$$

where V_{go} represents the bandgap voltage of silicon, Tᵣ represents a specified reference temperature, V_{BE} (Tᵣ) represents the base-emitter junction voltage at temperature Tᵣ, n represents a process-dependent constant, and x represents a constant related to junction current characteristics, in addition to the other variables described for equation (1). By designating one of the expressions containing all constants from equation (2) as:

$$α = [ ( 4 - n ) - x ] \frac{η k}{q} \qquad ( 3 )$$

equation (3) may be re-written as:

$${V}_{BE} ( T ) = {V}_{go} - T * \frac{1}{{T}_{r}} [ {V}_{go} - {V}_{BE} ( {T}_{r} ) - α {T}_{r} ln ( {T}_{r} ) ] - α T ln ( T ) . \qquad ( 4 )$$

Assigning a single value to another combination of constants in equation (4):

$$β = \frac{1}{{T}_{r}} [ {V}_{go} - {V}_{BE} ( {T}_{r} ) - α {T}_{r} ln ( {T}_{r} ) ] , \qquad ( 5 )$$

equation (4) may further be simplified as:
V_{BE}(T)=V_{go}−βT−αT ln(T). (6)

It may be observed from equation (6) that the base-emitter voltage, V_{BE} (T), is defined by three terms. The first term is a constant, V_{go}, the bandgap voltage of the semiconductor material, in this case silicon. The second term is a linear function of absolute temperature, T, that has a coefficient of −β and the last term is a non-linear function in the form of −αT ln(T). The last term corresponds to the effects that give rise to a non-linear curvature characteristic of a reference voltage that is generated by a bandgap reference. Eliminating this non-linear curvature characteristic may result in a substantially increased accuracy of circuits that rely on a reference voltage generated by a bandgap reference, for example the ADC or ADCs configured in temperature sensor circuits.

In order to create a constant voltage across all operating temperatures, the V_{BE} (T) voltage described in equation (6) may be combined with a second voltage that may cancel out linear and non-linear portions, leaving only the constant V_{go}. Therefore, a new voltage added to V_{BE} (T) may have the form shown in equation (7) below.
V_{PTAT}=βT+αT ln(T). (7)
The subscript “PTAT” in V_{PTAT} is indicative of the linear term βT being proportional to absolute temperature. The voltage V_{PTAT} that is proportional to absolute temperature may be created using two V_{BE} junctions operating at different emitter current densities.

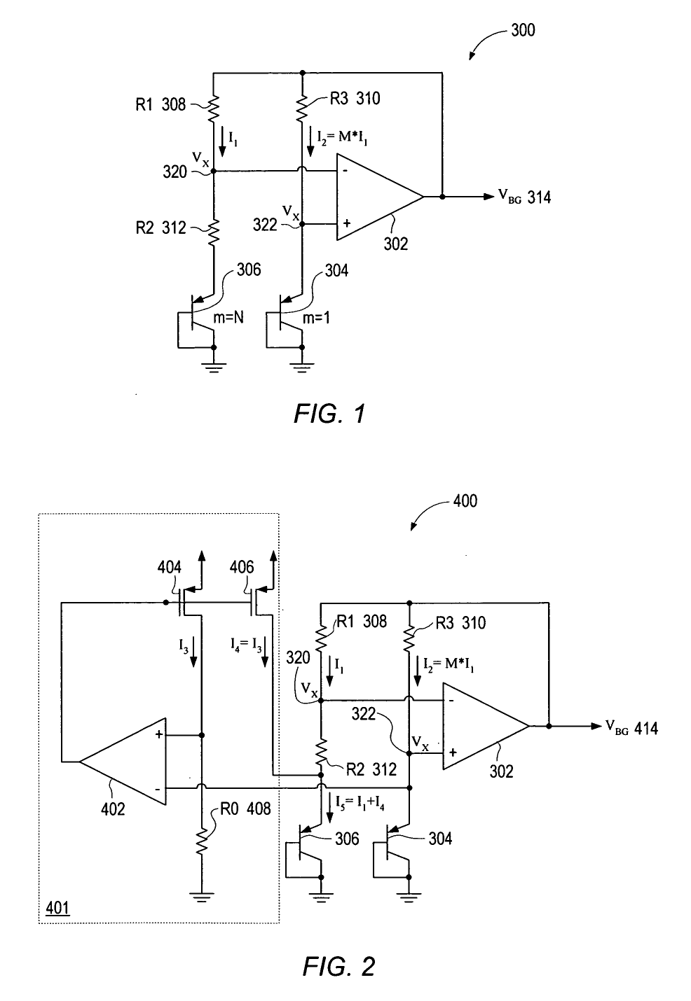

FIG. 1 illustrates a circuit topology 300 that may be used to generate a bandgap voltage V_{BG} 314, which includes generating V_{PTAT}. As shown, emitter area m of transistor 306 may be N times the emitter area of transistor 304, resulting in differing emitter current densities between transistors 306 and 304. More specifically, transistor 306 may be considered a low emitter-current density transistor with respect to transistor 304. The output of amplifier 302 may drive resistors R1 308 and R3 310 such that the voltages at the inputs of amplifier 302 have the same value. Transistors 306 and 304 may be configured to conduct currents I₁ and I₂, respectively, through their base-emitter junctions, where I₂ is a constant ‘M’ multiple of I₁. Accordingly, the following equations may be used to describe the operation of circuit 300 from FIG. 1:
Vₓ=I₁*R2+V_{BE0}(T,I₁) (8)
Vₓ=V_{BE1}(T,I₂) (9)
I₂=M*I₁ (10)
where V_{BE0} and V_{BE1} represent the base-emitter voltages for transistors 306 and 304, respectively, and Vₓ represents the voltage at nodes 320 and 322. Equations (8), (9) and (10) may be combined to form:

$${I}_{1} = \frac{1}{R 2} [ \begin{matrix}\frac{η kT}{q} ln ( \frac{N * {I}_{1}}{{I}_{S}} ) - \\ \frac{η kT}{q} ln ( \frac{{I}_{1}}{N * {I}_{S}} )\end{matrix} ] = \frac{1}{R 2} * \frac{η kT}{q} ln ( MN ) , \qquad ( 11 )$$

and equations (11) and (6) may be combined to obtain:

$${V}_{BG} = {V}_{X} + {I}_{1} * R 1 = {V}_{go} - β T - α T ln ( T ) + \frac{R 1}{R 2} * \frac{η kT}{q} ln ( MN ) . \qquad ( 12 )$$

The term αT ln(T) may be expanded into a power series because it comprises a linear component that may be canceled along with the −β term to obtain a final, zero temperature coefficient output voltage. Thus, the following power series may be obtained:
αT ln(T)=a₁T+a₂T²+a₃T³+ . . . (13)
Equations (12) and (13) may be combined to obtain

$$\begin{matrix}{V}_{BG} = {V}_{X} + {I}_{1} * R 1 \\ = {V}_{go} - ( β + {a}_{1} ) T - ( {a}_{2} {T}^{2} + {a}_{3} {T}^{3} + … ) + \\ \frac{R 1}{R 2} * \frac{η kT}{q} ln ( MN ) .\end{matrix} \qquad ( 14 )$$

By establishing the relationship:

$$\frac{R 1}{R 2} * \frac{η k}{q} ln ( MN ) = β + {a}_{1} , \qquad ( 15 )$$

V_{BG} may be expressed as:
V_{BG}=V_{go}−(a₂T²+a₃T³+ . . . ). (16)

As indicated by equation (16), a circuit configuration as exemplified by circuit 300 would not eliminate the non-linear component of the base-emitter junction voltage, which may result in the circuit output voltage V_{BG} 314 not being constant over temperature, featuring instead a predominantly second order negative curvature.

FIG. 2 illustrates one embodiment of a bandgap reference circuit 400, which may operate such that the −αT ln(T) component is eliminated, resulting in a constant reference voltage output V_{BG} 414. Circuit 400 is similar to circuit 300 of FIG. 1 with the exception of a new current I₄ being generated and applied to the emitter of transistor 306, resulting in a total current of I₅=I₁+I₄ flowing through the base-emitter junction of transistor 306. New current I₄ may be used to produce the needed +αT ln(T) term to be added to output voltage V_{BG} 414, thereby canceling the undesirable curvature that may otherwise be present in V_{BG} 414.

The output of amplifier 302 may again drive resistors R1 308 and R3 310 such that the voltages at the inputs of amplifier 302 have the same value, Vₓ. Under this condition, the following equations may be used to model the operation of circuit 400:
Vₓ=V_{BE1}(T,I₂) (17)
Vₓ=I₁*R2+V_{BE0}(T,I₅), and (18)
I₅=I₁+I₄ (19)
where, again, V_{BE0} and V_{BE1} represent the base-emitter voltages for transistors 306 and 304, respectively, and Vₓ represents the voltage at nodes 320 and 322. Combining equations (17), (18) and (19):

$$\begin{matrix}{I}_{1} = \frac{1}{R 2} [ \frac{η kT}{q} ln ( \frac{M * {I}_{1}}{{I}_{S}} ) - \frac{η kT}{q} ln ( \frac{{I}_{1} + {I}_{4}}{N * {I}_{S}} ) ] \\ = \frac{1}{R 2} * \frac{η kT}{q} ln ( MN * \frac{{I}_{1}}{{I}_{1} + {I}_{4}} ) .\end{matrix} \qquad ( 20 )$$

An equation may now be derived for I₄. In one embodiment, the output of amplifier 402 may be configured to drive PMOS transistor 404 such that the voltage at the non-inverting input of amplifier 402 is the same as the voltage at the non-inverting input of amplifier 302. PMOS transistor 406 may be configured to mirror PMOS transistor 404, thereby ensuring that currents I₃ and I₄ are equal. Under this condition the following equations may be used to further model the operation of circuit 400:

$$\begin{matrix}{I}_{3} = \frac{{V}_{BE 1} ( T , {I}_{2} )}{R 0} = \frac{1}{R 0} * ( {V}_{go} - β T - α T ln ( T ) ) & ( 21 ) \\ {I}_{4} = {I}_{3} & ( 22 )\end{matrix}$$

By establishing the relationship:
φ=β+a₁ (23)
I₄ may be expressed as:

$${I}_{4} = \frac{{V}_{go}}{R 0} - \frac{φ T}{R 0} . \qquad ( 24 )$$

It should be noted that in order to simplify the analysis, the higher order term of equation (21) may be omitted in equation (24), as I₄ operates to cancel higher order effects in negative to absolute temperature (NTAT) current injecting circuit 401, hence its higher order characteristics may be considered negligible with respect to the final results.

Equation (24) indicates that I₄ comprises a constant current term, V_{go}/R0, and a term that is negatively proportional with respect to absolute temperature, that is, it has an NTAT characteristic φT/R0. Combining equations (20) and (24), I₁ may be expressed as:

$${I}_{1} = \frac{1}{R 2} * \frac{η kT}{q} ln ( MN * \frac{{I}_{1}}{{I}_{1} + \frac{{V}_{go}}{R 0} - \frac{φ T}{R 0}} ) . \qquad ( 25 )$$

As equation (25) indicates, I₁ is proportional to absolute temperature (PTAT), and is expected to have the desired form shown in equations (7) and (13), as expressed in:
I₁ =λT+φT ln(T)≅ψT. (26)
The higher order effects of I₁ may be ignored since they may be negligible. Therefore, equation (25) may be combined with equation (26), to form:

$${I}_{1} = \frac{1}{R 2} * \frac{η kT}{2} ln ( MN ) + \frac{1}{R 2} * \frac{η kT}{q} ln ( \frac{ψ T}{\frac{{V}_{go}}{R 0} + ( ψ - \frac{φ}{R 0} ) * T} ) . \qquad ( 27 )$$

When selecting R0 408 to meet

$$R 0 = \frac{φ}{ψ} , \qquad ( 28 )$$

equation (27) may be reduced to:

$${I}_{1} = \frac{1}{R 2} * \frac{η kT}{q} ln ( MN * \frac{R 0 * ψ * T}{{V}_{go}} ) . \qquad ( 29 )$$

Bandgap voltage V_{BG} 414 may now be determined:

$$\begin{matrix}{V}_{BG} = {V}_{BE 1} ( T , {I}_{2} ) + {I}_{1} * R 1 \\ = {V}_{go} - β T - α T ln ( T ) + \frac{R 1}{R 2} * \frac{η kT}{q} ln ( MN * \frac{R 0 * ψ * T}{{V}_{go}} ) .\end{matrix} \qquad ( 30 )$$

In order to simplify equation (30), five constants may be assigned to and replaced by a single constant:

$$C = MN * \frac{R 0 * ψ}{{V}_{go}} \qquad ( 31 )$$

Therefore:

$$\begin{matrix}{V}_{BG} = {V}_{go} - β T - α T ln ( T ) + \frac{R 1}{R 2} * \frac{η kT}{q} ln ( CT ) , \\ and & ( 32 ) \\ {V}_{BG} = {V}_{go} - β T - α T ln ( T ) + \frac{R 1}{R 2} * \frac{η kT}{q} ln ( C ) + \frac{R 1}{R 2} * \frac{η kT}{q} ln ( T ) & ( 33 )\end{matrix}$$

R1 and R2 may be assigned values such that:

$$\frac{R 1}{R 2} * \frac{η k}{q} = α = [ ( 4 - n ) - x ] \frac{η k}{q} , \qquad ( 34 )$$

leading to a ratio of R1 to R2:

$$\frac{R 1}{R 2} = [ ( 4 - n ) - x ] . \qquad ( 35 )$$

As previously described, ‘n’ and ‘x’ represent constants related to process characteristics, leading to a ratio of R1 and R2 that may be well defined for a certain process. Once the ratio of R1 to R2 has been determined, C may be assigned a value such that:

$$\frac{R 1}{R 2} * \frac{η k}{q} ln ( C ) = β = \frac{1}{{T}_{r}} [ {V}_{go} - {V}_{BE} ( {T}_{r} ) - α {T}_{r} ln ( {T}_{r} ) ] . \qquad ( 36 )$$

It should also be noted that during manufacturing of bandgap reference circuit 300, it may be necessary to trim certain elements of the circuit in order to account for effects of process variation and/or temperature. In some embodiments, resistor R2 312 may typically be trimmed during manufacturing (for example by cutting/leaving uncut fuses) to insure that errors in the output of V_{BG} 314 due to process variations are eliminated. Upon trimming R2 312 however, additional residual curvature may be introduced into the circuit at the expense of correcting the nominal value of V_{BG} 314. In contrast, during manufacturing of bandgap reference circuit 400, R0 408 may also be trimmed in conjunction with R2 312, resulting in no residual curvature being introduced, thereby keeping V_{BG} 414 at its intended value during regular operation. In other words, when performing the trimming operation during manufacturing of bandgap reference circuit 400, R2 312 may be trimmed to bring V_{BG} 414 to its intended (designed) value, while R0 408 may be trimmed concurrently without affecting the value of V_{BG} 414 but maintaining the curvature correction established by current injecting circuit 401.

Thus, various embodiments of the systems and methods described above may facilitate the design of a bandgap reference capable of generating a curvature corrected reference voltage. Although the embodiments above have been described in considerable detail, for example specifying operational amplifiers, bipolar junction transistors, and PMOS transistors, other versions are possible, and some or all of the devices may be replaced with alternate devices that perform similar functions. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

We claim:

1. A bandgap reference circuit operable to generate a reference voltage, the bandgap reference circuit comprising:
a first PN-junction operable to conduct a first current that has a first characteristic with respect to temperature, wherein a device voltage developed across the first PN-junction in response to the first current exhibits a non-linearity (curvature) with respect to temperature;
a second PN-junction coupled to the first PN-junction; and
a control circuit configured to inject a control current that has a second characteristic with respect to temperature into the second PN-junction, wherein the second characteristic is opposite of the first characteristic;
wherein by injecting the control current into the second PN-junction, the control circuit operates to substantially reduce and/or eliminate an effect the non-linearity (curvature) has on the reference voltage.

2. The bandgap reference circuit of claim 1, wherein the first characteristic comprises a proportional to absolute temperature (PTAT) characteristic, and the second characteristic comprises negative to absolute temperature (NTAT) characteristic.

3. The bandgap reference circuit of claim 1, further comprising:
an amplifier having a first input and a second input, and an output;
wherein the first input of the amplifier is configured to couple to the first PN-junction;
wherein the second input of the amplifier is configured to couple to the second PN-junction; and
wherein the output of the amplifier is configured to provide the reference voltage.

4. The bandgap reference circuit of claim 3, further comprising:
a first resistance configured to couple between the output of the amplifier and the first input of the amplifier;
a second resistance configured to couple between the output of the amplifier and the second input of the amplifier; and
a third resistance configured to couple between the second input of the amplifier and the second PN-junction.

5. The bandgap reference circuit of claim 3, wherein the amplifier comprises an operational amplifier, and wherein the first input of the amplifier is a non-inverting input and the second input of the amplifier is an inverting input.

6. The bandgap reference circuit of claim 1, wherein the control circuit comprises:
an amplifier having a first input and a second input, and an output, wherein the first input of the amplifier is configured to couple to the first PN-junction;
a first transistor with a control terminal and a pair of end terminals, wherein a first one of the pair of end terminals of the first transistor is configured to couple to the second PN-junction, and wherein the control terminal of the first transistor is configured to couple to the output of the amplifier; and
a second transistor with a control terminal and a pair of end terminals, wherein a first one of the pair of end terminals of the second transistor is configured to couple to the second input of the amplifier, and wherein the control terminal of the second transistor is configured to couple to the output of the amplifier.

7. The bandgap reference circuit of claim 6, wherein the control circuit further comprises a first resistance configured to couple between the second input of the amplifier and ground.

8. The bandgap reference circuit of claim 6, wherein the first transistor comprises a first p-channel metal-oxide semiconductor (PMOS) device and the second transistor comprises a second PMOS device, wherein a drain terminal of the first PMOS device is the first one of the pair of end terminals of the first transistor, and wherein the drain terminal of the second PMOS device is the first one of the pair of end terminals of the second transistor.

9. The bandgap reference circuit of claim 8, further comprising:
a second resistance configured to couple between the output of the amplifier and the first input of the amplifier;
a third resistance configured to couple between the output of the amplifier and the second input of the amplifier; and
a fourth resistance configured to couple between the second input of the amplifier and the second PN-junction.

10. The bandgap reference circuit of claim 9, wherein the fourth resistance is configured to be trimmed during manufacturing of the bandgap reference circuit to compensate for an error in the reference voltage caused by process variation.

11. The bandgap reference circuit of claim 10, wherein the first resistance is configured to be trimmed during manufacturing of the bandgap reference circuit to eliminate a curvature error introduced in the reference voltage when the fourth resistance is trimmed;
wherein no additional error is caused in the reference voltage by trimming the first resistance.

12. The bandgap reference circuit of claim 1, wherein the first PN-junction is comprised in a first bipolar junction transistor (BJT), and the second PN-junction is comprised in a second BJT.

13. The bandgap reference circuit of claim 12, wherein an emitter-current density of the second BJT is lower than an emitter-current density of the first BJT.

14. The bandgap reference circuit of claim 12, wherein an emitter terminal of the first BJT and an emitter terminal of the second BJT are both configured to couple to the control circuit.

15. A method for operating a bandgap reference circuit, the method comprising:
powering the bandgap reference circuit, wherein the bandgap reference circuit comprises a first PN-junction coupled to a second PN-junction, wherein in response to said powering:
a base-emitter voltage (V_{BE}) of the first PN-junction exhibits a non-linearity (curvature) with respect to temperature; and
the first PN-junction conducts a first current having a first characteristic with respect to temperature;
a control current having a second characteristic with respect to temperature is injected into the second PN-junction, wherein the second characteristic is opposite of the first characteristic;
the bandgap reference circuit generating a reference voltage in response to said powering, wherein the control current reduces and/or eliminates an effect the non-linearity (curvature) has on the reference voltage.

16. The method of claim 15, further comprising the second PN-junction conducting a second current, wherein the second current comprises a sum of the control current and a third current, wherein the first current is a multiple of the third current;
wherein the third current is neutral with respect to temperature.

17. A method comprising:
a V_{BE} of a first PN-junction exhibiting a non-linearity (curvature) with respect to temperature;
the first PN-junction conducting a first current having a first characteristic with respect to temperature; and
injecting a control current having a second characteristic with respect to temperature into a second PN-junction coupled to the first PN-junction, wherein the second characteristic is opposite of the first characteristic;
wherein said injecting reduces and/or eliminates an effect the non-linearity (curvature) has on an output of a bandgap voltage reference generator, wherein the bandgap voltage reference generator includes the first PN-junction and the second PN-junction.
